(19) United States
(12) Patent Application Publication
(10) Pub. No.: US 2008/0194141 A1
(43) Pub. Date: Aug. 14, 2008

(54) Electrical connector

(75) Inventors: Zhe-Feng Wu, Kunshan (CN); Di-Gui Ma, Kunshan (CN); Zhi-Ming Wu, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/069,233

(22) Filed: Feb. 7, 2008

(30) Foreign Application Priority Data
Feb. 9, 2007 (CN) 200720034622.1

(51) Int. Cl. H01R 13/73

(52) U.S. Cl. 439/571; 439/625

(57) ABSTRACT

An electrical connector includes an insulative housing with a plurality of terminals retained therein, a shell and a pair of position sheets. The housing comprises a pair of retaining protrusions, an installing hole is defined through every retaining protrusion. The position sheet covers on each retaining protrusion, and has a position hole therethrough corresponding to the installing hole. The retaining protrusions are assembled on a PCB, and provide a retaining force for retaining the housing on the PCB, the position sheets decrease the influence of distortion of the protrusions and make the electrical connection between the terminals and the PCB more reliable thereby.

### BACKGROUND OF THE INVENTION

1. Field of the Invention

The present invention relates to an electrical connector, especially to an electrical connector having board locks for securing the electrical connector onto a printed circuit board (PCB).

2. Description of the Related Art

A conventional electrical connector described as a prior art in U.S. Pat. No. 5,797,769 issued on Aug. 25, 1998 comprises an elongated dielectric housing 14, a plurality of terminals 28 with tail portions 30 inserting into a pattern of holes in the PCB, and a shield 16 partially enclosing the housing 14. The electrical connector 10 defines a pair of boardlocks 12 at two opposite ends of the housing 14, each boardlock 12 includes a square, generally planar mounting plate 36 held to a rear terminating face 22 of the housing 14 and a locking leg 40 extending downwardly for inserting into the PCB. The soldering area of the boardlock 12 and the PCB is very small due to the small volume of the locking leg 40, and so there is not sufficient soldering force for retaining the connector 10 on the PCB, the electrical connector 10 will rock while accepting a mating and unmating force, and thereby the connection between terminals 28 and the circuit traces on the PCB will become unstable, and it also will influence the transmission of the signals.

Another conventional electrical connector described in the U.S. Pat. No. 5,194,010 issued on Mar. 16, 1993 comprises a housing 15 with a pair of backwardly extending flanges 26 at two opposite ends, each flange 26 provides with a hole 28 therethrough for receiving a mounting device 62 for surface mounting housing 15 on a PCB. The flange 26 will become distorted, e.g. warp when the connector is soldered onto the PCB through a high temperature, therefore it can't ensure a reliable electrical connection between the electrical connector and PCB.

Hence, it is desirable to provide an improved electrical connector to overcome the aforementioned disadvantages.

### SUMMARY OF THE INVENTION

Accordingly, the object of the present invention is to provide an electrical connector with board locks, which can make the electrical connector be mounted on a PCB stably, thereby ensuring a reliable electrical connection between the electrical connector and the PCB.

In order to achieve the above-mentioned object, an electrical connector in accordance with the present invention comprises an insulative housing with a plurality of passageways extending theretrough, a plurality of terminals received in the passageways, a shell partially enclosing the housing, a pair of position sheets and a pair of fasteners assembling the position sheets onto the housing. The housing defines a pair of retaining protrusions extending therefrom, the retaining protrusion has an installing hole therethrough. The position sheet covers on the retaining protrusion, and has a position hole corresponding to the installing hole.

Other features and advantages of the present invention will become more apparent to those skilled in the art upon examination of the following drawings and detailed description of preferred embodiments.

### BRIEF DESCRIPTION OF THE DRAWINGS

FIG. 1 is an assembled perspective view according to a preferred embodiment of the present invention;

FIG. 2 is an exploded perspective view of the electrical connector of FIG. 1;

FIG. 3 is a view similar to FIG. 2, but taken from another perspective;

FIG. 4 is a partially assembled perspective view of the present invention; and

FIG. 5 is an assembled view taken from a bottom view.

### DETAILED DESCRIPTION OF PREFERRED EMBODIMENT

Reference will now be made to the drawing figures to describe the preferred embodiment of the present invention in detail.

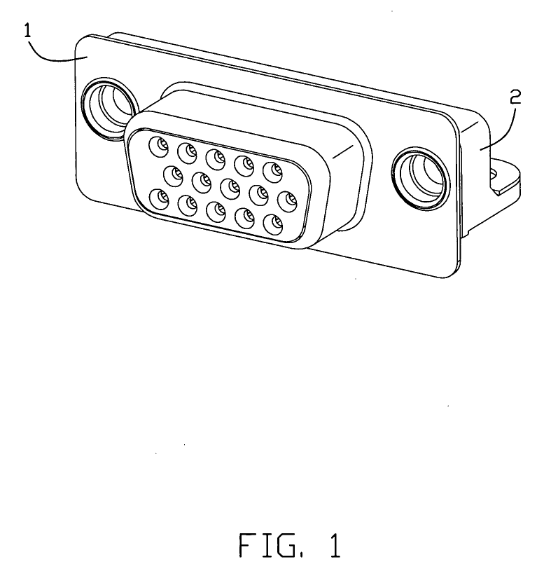

Referring to FIGS. 1 to 5, an electrical connector in accordance with the present invention comprises an insulative housing 2 with a plurality of terminals 3 assembled therein, a shell 1 partially enclosed the housing 2, a pair of board locks 4 attached to the housing 2, a pair of fasteners 5 assembling the board locks 4 onto the housing 2 and a spacer 6 attached to the housing 2.

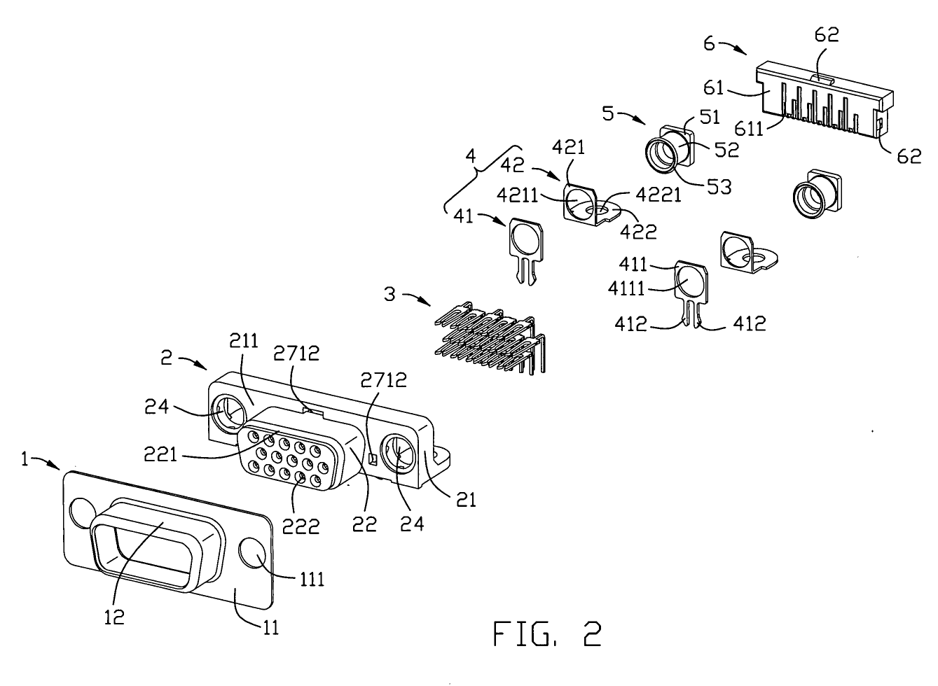

Referring to FIG. 2, the shell 1 comprises a blade-shaped base portion 11, a D-shaped enclosing portion 12 drawn forwardly from the base portion, and a pair of apertures 111 defined at two opposite ends of the base portion for being inserted the fasteners 5 therethrough.

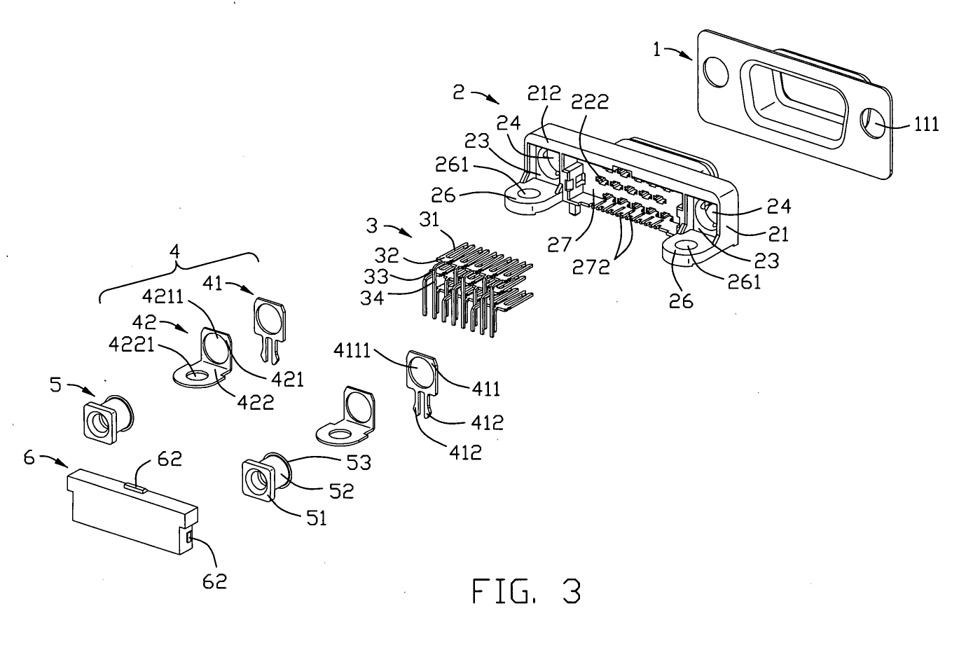

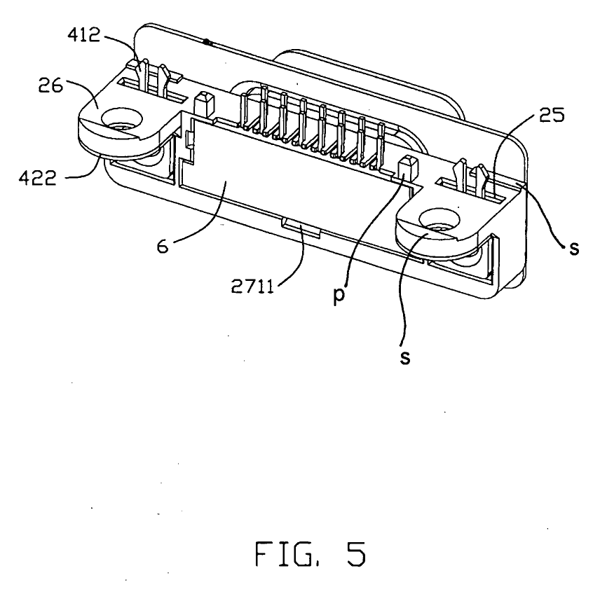

Referring to FIGS. 2 and 3, the housing 2 comprises a lengthwise base portion 21 and a D-shaped mating portion 22 extending forwardly from a front mating face 211 of the base portion 21. The mating portion 22 is accepted in the enclosing portion 12 of the shell 1. The housing 2 defines a plurality of passageways 222 passing through the mating portion 22 and the base portion 21 for receiving the terminals 3. The base portion 21 has a rear engaging face 212 relative to the front mating face 211. An opening 27 and a pair of recesses 23 are defined on the rear engaging face 212 seperately. The opening 27 is in the center of the base portion 21 corresponding to the mating portion 22, the recesses 23 are defined at two opposite ends of the base portion 21 with a cavity 24 passing through the front mating face 211 corresponding to the aperture 111 of the shell 1. Each recess 23 has a gap 25 (see in FIG. 5) recessed downwardly and through the bottom of the base portion 21. A lower wall of the opening defines a plurality of slits 272 passing through the bottom of the housing for positioning the terminals 3. The passageways 222 on the rear engaging face 212 is cross shaped. A retaining protrusion 26 with an installing hole 261 theretrough extends backwardly from the bottom of each recess 23 for supporting the board lock 4 and assembling the electrical connector onto a PCB (not shown).

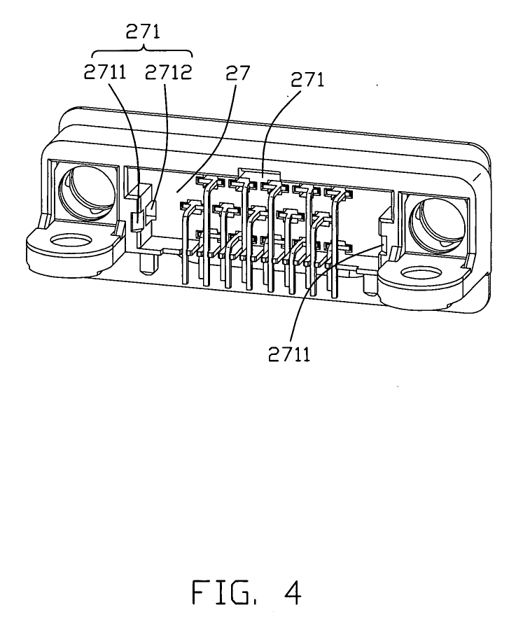

Referring to FIG. 3, the terminals 3 are arranged in three rows. Each terminal is in L shape and includes a tuning fork shaped contact section 31, a retaining section 32 extending backwardly from the contact section 31, a solder section 34 perpendicular to the contact section 31 and a connecting section 33 linking with the retaining section 32 and the solder section 34. The contact sections 31 and the retaining sections 32 are respectively received in the passageways 222 of the mating portion 22 and the base portion 21, the connecting sections 33 and the solder sections 34 are in the opening 27, the solder sections 34 are inserted in the slits 272 as FIG. 4 shown.

Referring to FIG. 3, the board lock 4 includes a pair of inserting sheets 41 and a pair of L-shaped position sheets 42. Each inserting sheet 41 includes a main portion 411 received in the recess 23 and a pair of pawls 412 being inserted into the gaps 25 (see in FIG. 5) and soldered to the PCB. The main portion 411 is in the same shape with the recess 23 and has a matchable hole 4111 corresponding to the cavity 24. Each position sheet 42 has a horizontal portion 422 and a vertical portion 421. The vertical portion 421 is attached to the main portion 411 of the inserting sheet 41, and the vertical portion 421 defines a through hole 4211 therethrough corresponding to the matchable hole 4111. The horizontal portion 422 is covered on the retaining protrusion 26 and has a position hole 4221 therethrough corresponding to the installing hole 261 of the protrusion 26 for a bolt (not shown) passing through and installed on the PCB.

The fastener 5 has a base plate 51 and a cylinder 52 extending from the base plate 51. The cylinder 52 passes through the through hole 4211 of the position sheet 42, the matchable hole 4111 of the inserting sheet 41, the cavity 24 of the recess 23 and the aperture 11 of the shell 1 to join the shell 1, the housing 2 and the board locks 4 together. The cylinder 52 has a free end 53 riveted on a front surface of the shell 1.

Referring to FIG. 2 and FIG. 3, the spacer 6 is in rectangular board shape and is received in the opening 27 of the base portion 21, it has a plurality of slots 611 on a board surface 61 for positioning the solder sections 34 of the terminals 3. It contains tubers 62 at the opposite ends and the top face be attached to fastening portions 271 defined on sidewalls and the inner top wall of the opening 27 (seen in FIG. 4). Each fastening portion 271 includes a declined plane 2711 and a hole 2712 through the front mating face 211, the declined plane 2711 can guide the tuber 62 into the hole 2712, and position the spacer 6 in the opening 27 thereby.

The retaining protrusions 26 position is used to the electrical connector on the PCB by a bolt, so the retaining force of the electrical connector can be enhanced and the electrical connector could keep balance while being exerted a mating and unmating force. The position sheet 42 is covered on the retaining protrusion 26 to prevent the retaining portion 26 from distortion when in a high temperature since the position sheet is metal material, thereby a stable retention between the electrical connector and the PCB is established. It is noted that there are optional standoffs S located on an undersurface of the retaining protrusion 26 by two sides of the pawl 42 and the unlabeled bolt which extends through the installing hole 261 and the associated position hole 4221. Moreover, the positioning post P is optionally provided by two sides of the solder sections 34 of the terminal 3. In addition, a bottom portion of the shell 1 is essentially located below a bottom portion of the housing 2 so as to be located at the same level with the printed circuit board on which the housing 2 is mounted. From another viewpoint, it is noted that in the current embodiment the bottom portion of the mating portion 22 is located below the bottom face of the base portion 21 of the housing. This unique structure allows a lower profile arrangement of the connector relative to the corresponding PCB (not shown) without necessitating the sink type configuration, i.e., the connector being located in a notch of the PCB (not shown).

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. An electrical connector adapted to be mounted on a PCB comprising:
an insulative housing defining a plurality of passageways extending therethrough, and a pair retaining protrusions extending therefrom, the retaining portion defining an installing hole which is used for assembling the protrusion on the PCB;
a plurality of terminals retained in the passageways of the housing;
a pair of position sheets cover on the protrusions, the position sheet having a position hole corresponding to the installing hole;
a pair of fastener assembling the position sheet onto the housing.

2. The electrical connector of claim 1, wherein the housing has a base portion with a front mating face, a rear engaging face relative to the front mating face and a bottom face, a mating portion extending forwardly from the front mating face, the passageways are defined through the mating portion and the base portion.

3. The electrical connector of claim 2, wherein the a position sheet is in L shape and comprises a horizontal portion and a vertical portion defining a through hole therein, the position hole is defined in the horizontal portion.

4. The electrical connector of claim 3, wherein a pair of inserting sheets are attached on the housing, the inserting sheet includes a main portion which has a matchable hole therethrough corresponding to the through hole for the fastener.

5. The electrical connector of claim 4, wherein the base portion defines a pair of gaps through the bottom face, the inserting sheet has a pair of pawls extending downwardly from the main portion, the pawls are inserted into the gap and the PCB.

6. The electrical connector of claim 4, wherein the base portion defines a pair of cavities through the front mating face and the rear engaging face at two opposite ends, the cavity is corresponding to the through hole for being passed by the fastener.

7. The electrical connector of claim 6, wherein the base portion defines a pair of recesses on the rear engaging face for receiving the inserting sheets and the position sheet therein, the cavity is in the recess.

8. The electrical connector of claim 2, wherein the electrical connector further includes a shell which comprises a base portion and an enclosing portion extending therefrom for receiving the mating portion.

9. The electrical connector of claim 2, wherein each terminal includes a solder section, the base portion defines an opening on the rear engaging face for receiving the solder sections therein.

10. The electrical connector of claim 9, wherein the opening is engaged with a spacer which defining a plurality of slots thereon for positioning the solder sections.

11. The electrical connector of claim 10, wherein the opening defines at least a fastening portion, the spacer has at least a tuber mating with the fastening portion.

12. The electrical connector of claim 1, further including an insertion sheet with a pawl downwardly extending through the housing for locking to a printed circuit board on which the housing is seated, wherein said insertion sheet is fastened with the corresponding position sheet by the corresponding fastener.

13. The electrical connector of claim 12, wherein said housing defines a gap through which the insertion sheet is only allowed to be upwardly to the housing.

14. The electrical connector of claim 12, wherein said retaining protrusion is of an L-shaped configuration and said position sheet is of another L-shaped configuration abutting against said L-shaped configuration under a condition that the insertion sheet is sandwiched between the corresponding retaining protrusion and position sheet.

15. The electrical connector of claim 14, wherein said insertion sheet is sandwiched between the corresponding retaining protrusion and position sheet in a front-to-back direction.

16. An electrical connector comprising:
an insulative housing which has a base portion, a mating portion extending forwardly from the base portion and a plurality of passageways extending through the mating portion and base portion;
a plurality of terminals retained in the passageways of the housing;
a shell partially enclosing the housing therein;
at least a position sheet including a vertical portion with a through hole and a horizontal portion with a position hole therein; and
a pair of fasteners assembling the position sheet onto the housing.

17. An electrical connector assembly comprising:
an insulative housing including a base with a mating portion extending forwardly therefrom;
a plurality of passageways defines in the housing and extending through the base and the mating portion extending forwardly from a front face of the base under a condition that said mating portion is configured to be snugly received in a receiving cavity of a complementary connector when mated; a plurality of terminals disposed in the housing with corresponding mating sections located in the mating portion; and
a metallic shell including a vertical plate covering the front face of the base and defining a central opening, and a tubular portion extending from the vertical plate in alignment with said central opening, and circumferentially enclosing the mating portion; wherein
a bottom face of the mating portion of the housing is not higher than a bottom face of the base.

18. The connector assembly as claimed in claim 17, wherein the mating portion of the housing is asymmetrically arranged with the base of the housing in a vertical direction.

19. The connector assembly as claimed in claim 17, wherein a bottom edge of the vertical plate of said shell is below both the base and the mating portion of the housing with a distance.

20. The connector assembly as claimed in claim 19, further including a printed circuit board on which the housing is seated, wherein a bottom portion of the shell covers a front edge of the printed circuit board in a front-to-back direction.
